(19) United States
(12) Patent Application Publication
(10) Pub. No.: US 2023/0150669 A1
(43) Pub. Date: May 18, 2023

(54) MOTORCYCLE MOUNT FOR AN AIRCRAFT

(71) Applicant: CFD International, Princeton, TX (US)

(72) Inventors: Michael Fellegy, Whitesboro, TX (US); Russell Mensch, Parker, TX (US); David Dierks, McKinney, TX (US); Nathan Thompson, Farmersville, TX (US)

(21) Appl. No.: 17/454,745

(22) Filed: Nov. 12, 2021

(51) Int. Cl. B64D 9/00

(52) U.S. Cl. CPC B64D 9/00

(57) ABSTRACT

A mount configured to quickly attach to an aircraft, such as the MH-6 helicopter, for the use of quickly mounting and demounting a motorcycle without the use of tools. The mount attaches to the aircraft via support arms with ball-lock pins for a quick and toolless installation. The mount supports the motorcycle by supporting the body of the motorcycle by a first support and additionally stabilizes the motorcycle in place by use of a wheel brace, a wheel guide, a foot peg hook assembly, and a foot peg mount.

### TECHNICAL FIELD

The present subject matter relates to an apparatus for the mounting of a motorcycle to an aircraft.

### BACKGROUND

Certain aircraft, such as the MH-6 helicopter, are outfitted with various transport systems to better carry passengers, weapons, or equipment.

### BRIEF DESCRIPTION OF THE DRAWINGS

The drawing figures depict one or more implementations, by way of example only, not by way of limitations. In the figures, like reference numerals refer to the same or similar elements.

FIG. 1 illustrates a perspective view of a motorcycle coupled to an aircraft by a mount;

FIG. 2 illustrates a perspective view of the mount;

FIG. 3 illustrates a partial exploded view of the mount emphasizing a pair of support arms and a first support of the mount;

FIG. 4 illustrates a partial exploded view of the mount emphasizing a wheel guide;

FIG. 5 illustrates a partial exploded view of the mount emphasizing a foot peg hook;

FIG. 6 illustrates a partial exploded view of the mount emphasizing a wheel brace;

FIG. 7 illustrates a partial exploded view of the mount emphasizing a foot peg mount;

### DETAILED DESCRIPTION

A mount configured to quickly attach to an aircraft, such as the MH-6 helicopter, for the use of quickly mounting and demounting a motorcycle without the use of tools. The mount attaches to the aircraft via support arms with ball-lock pins for a quick and toolless installation. The mount supports the motorcycle by supporting the body of the motorcycle by a first support and additionally stabilizes the motorcycle in place by use of a wheel brace, a wheel guide, a foot peg hook assembly, and a foot peg mount.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, and components have been described at a relatively high-level, without detail, in order to avoid unnecessarily obscuring aspects of the present teachings.

The term “coupled” as used herein refers to any logical or physical link. Unless described otherwise, coupled elements or devices are not necessarily directly connected to one another and may be separated by intermediate components or elements. Reference now is made in detail to the examples illustrated in the accompanying drawings and discussed below.

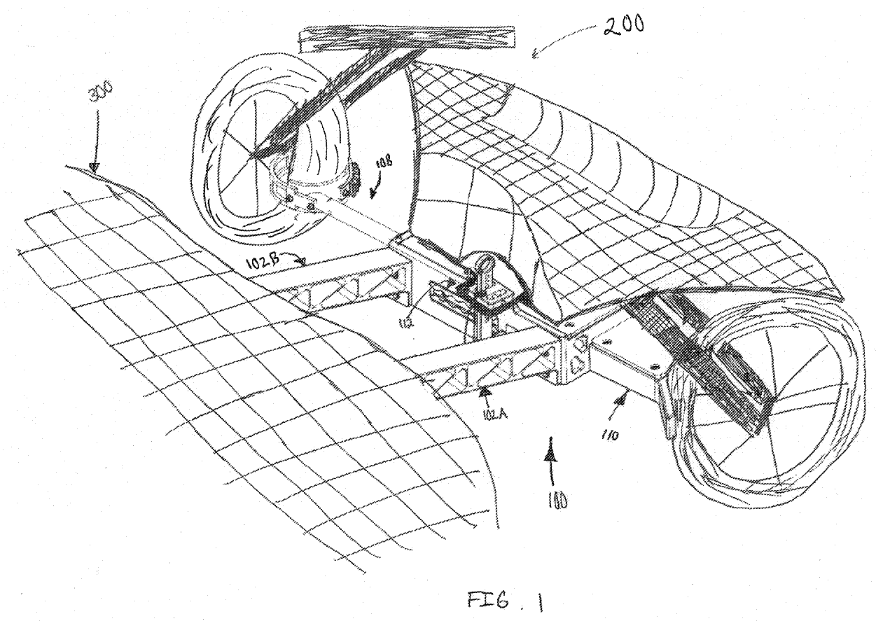

FIG. 1 illustrates a perspective view of a motorcycle 200 mounted to an aircraft 300, such as a MH-6 helicopter, via a mount 100 for quick mounting and demounting of the motorcycle 200 from the aircraft 300 without the use of tools. The mount 100 may couple to an aircraft directly or to an accessory installed on the aircraft. In an example, a troop transport system, which may also be a weapons platform, for the purpose of carrying cargo and personnel is installed on an MH-6 helicopter 300. The mount 100 couples to the bottom of the troop transport system via the lug and ball-lock pins 104 for the purpose of transporting a motorcycle 200.

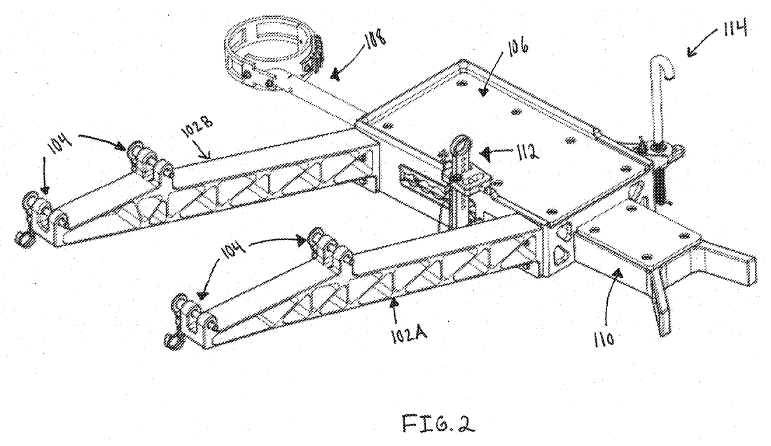

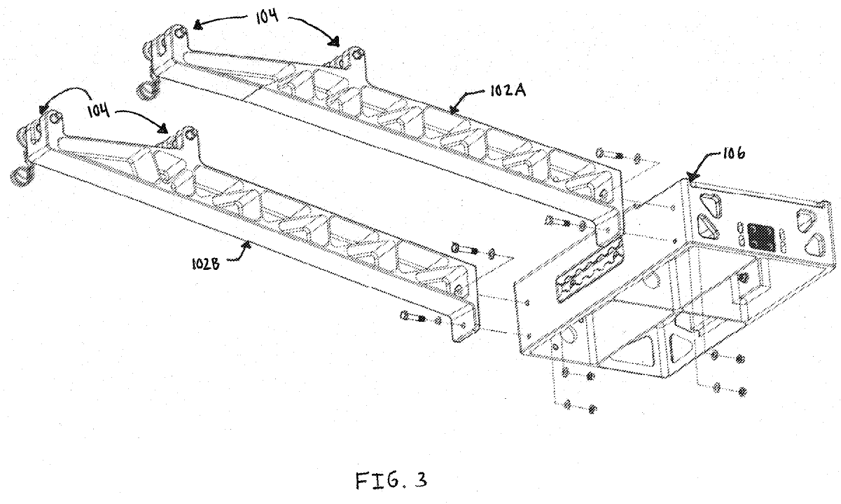

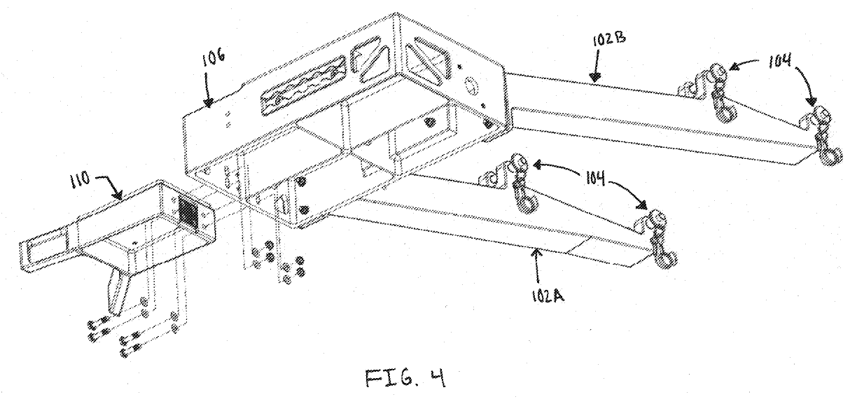

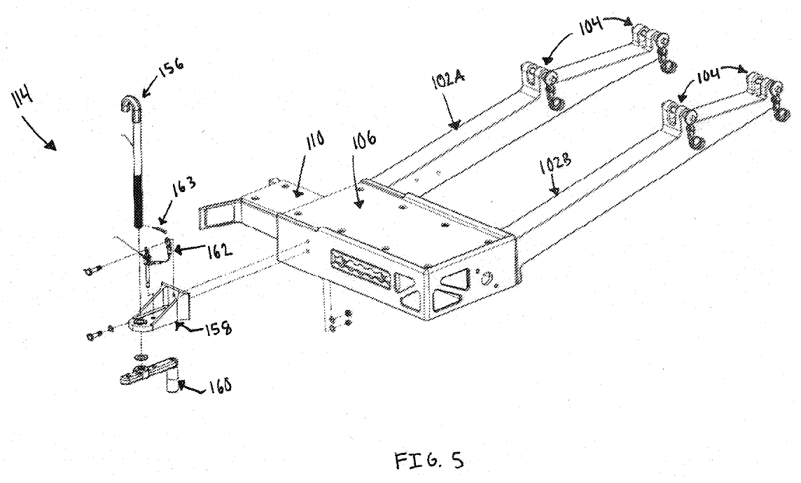

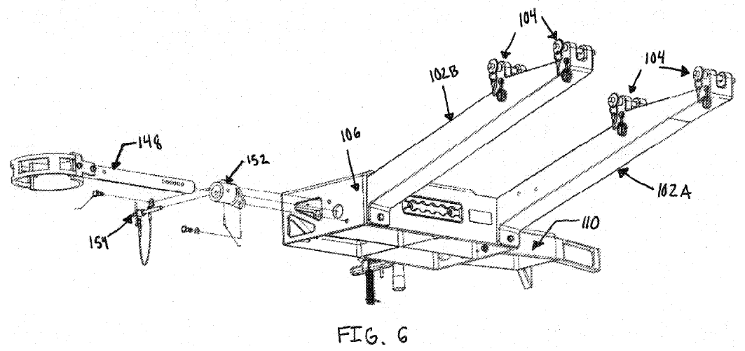

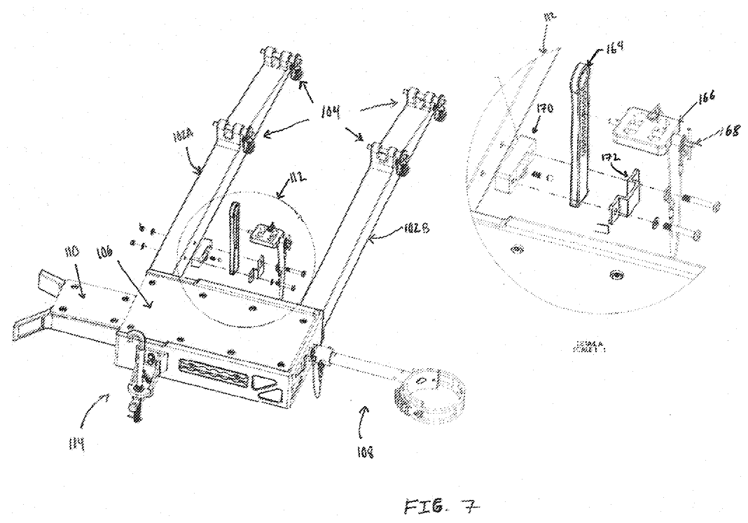

FIG. 2 illustrates a perspective view of the mount 100 with two support arms 102A-B configured to couple to the aircraft with lugs and ball-lock pins 104. The lugs and ball-lock pins 104 allow for a quick and easy installation of the mount 100 to the aircraft 300 without the need of tools. A first support 106 is coupled to the support arms 102A-B and is configured to support the weight of the motorcycle 200 by supporting the body of the motorcycle 200. The first support 106 is further described in FIG. 3. A wheel bracket 108 is coupled to the first support 106. The wheel bracket 108 is configured to couple to a front tire of the motorcycle 200 to prevent the lateral, longitudinal, and rotational movement of the front tire. The wheel bracket 108 is further described in FIG. 6. A wheel guide 110 is coupled to the first support 106. The wheel guide 110 is configured to cradle a rear wheel of the motorcycle 200 to prevent lateral movement of the rear wheel. The wheel guide 110 is further described in FIG. 4. A foot peg mount 112 is coupled to the support arm 102A. The foot peg mount 112 is configured to couple to a left foot peg of the motorcycle 200 to prevent the lateral rotation of the motorcycle 200. The foot peg mount 112 is described further in FIG. 7. A foot peg hook assembly 114 is coupled to the first support 106. The foot peg hook assembly 114 is configured to couple to a right foot peg of the motorcycle 200 to prevent the lateral rotation of the motorcycle 200. The foot peg hook assembly 114 is described further in FIG. 5. The mount 100 may be made out of a variety of materials rated to withstand the strain expected while in use. For example, aluminum, steel, metal alloys, other strong and lightweight materials, or any combination of these materials may be used in the construction of the mount.

FIG. 3 is a partial exploded view of the mount 100 emphasizing the support arms 102A-B and the first support 106. The support arms 102A-B are designed to maximize structural strength while minimizing the weight of the part. In one embodiment, the support arms have a truss design to maximize strength while reducing the amount of material needed to decrease the weight of the part. In another embodiment, the support arms 102A-B couple to the aircraft 300 via lugs and ball-lock pins 104. Other quick-connecting assemblies may also be used to attach the support arms 102A-B to the aircraft. The first support 106 is designed to maximize the strength of the part while also reducing its weight. In one embodiment, the first support 106 is coupled to the support arms 102A-B by bolts, washers, and nuts, but other types of fasteners may also be used. The first support 106 is configured to support the majority of the load of the motorcycle 200 by supporting the body of the motorcycle 200. In another embodiment, the first support 106 has a flat surface that contacts the underside of the body of the motorcycle 200. The flat surface is partially encompassed by raised edges to prevent the sliding of the motorcycle body off the flat surface of the first support 106.

FIG. 4 is a partial exploded view of the mount 100 emphasizing the wheel guide 110. The wheel guide 110 is coupled to the first support 106. In one embodiment, the wheel guide 110 is coupled to the first support 106 by bolts, washer, and nuts, but other types of fasteners may also be used. The wheel guide 110 is designed to maximize the strength of the part while also reducing its weight. The wheel guide 110 is configured to stabilize the rear wheel of the motorcycle 200 while it is mounted by preventing the lateral movement of the rear wheel of the motorcycle 200. In one embodiment, the wheel guide 110 is shaped similar to a ‘U’ or ‘V’ to surround the rear wheel by three sides.

FIG. 5 is a partial exploded view of the mount 100 emphasizing the foot peg hook assembly 114. The foot peg hook assembly 114 comprising of a hook 156, a pin 163, a lanyard pin 162, a bracket 158, and a handle 160. The hook 156 is coupled to the first support 106 via a bracket 158. In one embodiment, the bracket 158 is coupled to the first support 106 by bolts, washers, and nuts, but other fasteners may also be used. The lower body of the hook 156 is threaded and configured to slide through the bracket 158 to adjust for a variety of motorcycle 200 sizes. The pin 163 is configured to insert into the base of the hook 156 to prevent the handle 160 from falling off of the hook 156. The handle 160 is configured to receive the threaded portion of the hook 160 to adjust for varying motorcycle sizes. The handle 160 can be selectively coupled to the bracket 158 via the lanyard pin 162. In one embodiment, the foot peg hook 156 is coupled to the right foot peg of the motorcycle 200. The handle 160 is then rotated about the base of the hook 156 to accommodate for the size of motorcycle 200 that is mounted. The lanyard pin 162 is then used to couple the handle 160 to the bracket 158 to prevent the hook 156 from decoupling from the foot peg of the motorcycle 200. The foot peg hook assembly 114 helps prevent the movement, such as lateral, longitudinal, and rotational, of the motorcycle 200 in reference to the mount 100 while in transport.

FIG. 6 is a partial exploded view of the mount 100 emphasizing the wheel bracket 108. The wheel bracket 108 comprising of a bracket 152, a support post 148, a lanyard pin 154, and a wheel strap 150. The wheel bracket 108 is coupled to the first support via the bracket 152. In one embodiment, the bracket 152 is coupled to the first support by the use of bolts, washers, and nuts, but other fasteners may be used. The wheel strap 150 is coupled to the support post 148. In another embodiment, the support post 148 is then coupled to the bracket 152 via a lanyard pin 154. The support post 148 is configured to slide through the bracket 152 to adjust the length between the wheel strap 150 and the first support 106 to properly fit a variety of motorcycle 200 sizes. In another embodiment, the wheel strap 150 is made of a flexible rubber that can be adjusted for varying wheel sizes. The wheel strap 150 is configured to wrap around the front wheel of the motorcycle to prevent the movement, such as lateral, longitudinal, and rotational, of the front wheel, further securing the motorcycle 200 to the mount 100.

FIG. 7 is a partial exploded view of the mount 100 emphasizing the foot peg mount 112. The foot peg mount 112 comprising of brackets 170 and 172, a post 164, a peg mount 166, and a lanyard pin 168. The post 164 is coupled to the support arm 102A via the brackets 170 and 172. In one embodiment, the brackets 170 and 172 couple the post 164 to the support arm 102A via bolts, washers, and nuts, but other fasteners may be used. The peg mount 166 is coupled to the post 164 via the lanyard pin 168. The peg mount 166 may be attached at multiple points vertically along the post to adjust for varying motorcycle 200 sizes. The peg mount 166 couples to the top of a left foot peg of the motorcycle 200 to prevent movement, such as lateral, longitudinal, and rotational, of the motorcycle 200 in reference to the mount 100 during transport.

The mount 100, allows for the quick coupling and decoupling of the motorcycle 200 to the mount without the use of tools. In one embodiment, the motorcycle 200 is quickly attached to the mount 100 without the use of tools. The following may be done in any logical order. First, the body of the motorcycle 200 is placed upon the first support 106. The rear wheel is then positioned at the wheel guide 110 where it is surrounded by three sides. The right foot peg of the motorcycle 200 is then secured by the foot peg hook assembly 114. The left foot peg of the motorcycle 200 is then secured by the foot peg mount 112. The front wheel of the motorcycle 200 is then secured by the wheel strap 108. The motorcycle 200 may be quickly decoupled from the mount by decoupling the wheel strap 108, the foot peg mount 108, and the foot peg hook assembly 114. The motorcycle may then be removed from the mount 100.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A mount, configured to couple a motorcycle to an aircraft, comprising:
a support arm configured to couple to the aircraft;
a first support coupled to the support arm; and
a second support coupled to the first support.

2. The mount of claim 1, wherein the mount is configured to couple and decouple to the motorcycle without the use of tools.

3. The mount of claim 2, wherein the mount is configured to couple and decouple to the aircraft without the use of tools.

4. The mount of claim 3, wherein the aircraft is a helicopter.

5. The mount of claim 1, wherein the first support in configured to support the body of the motorcycle.

6. The mount of claim 5, wherein the second support is configured to couple to a first wheel of the motorcycle.

7. The mount of claim 6, wherein the second support is configured to prevent the lateral rotation of the first wheel, wherein the first wheel is a front wheel of the motorcycle.

8. The mount of claim 6, further comprising a third support coupled to the first support, wherein the third support is configured to cradle a second wheel of the motorcycle.

9. The mount of claim 8, wherein the third support is shaped as a ‘U’, wherein the second wheel is a rear wheel of the motorcycle.

10. The mount of claim 8, further comprising of a fourth support coupled to the first support, wherein the fourth support is configured to couple to a first foot peg of the motorcycle.

11. The mount of claim 10, further comprising of a fifth support coupled to the support arm, wherein the fifth support is configured to couple to a second foot peg of the motorcycle.

12. The mount of claim 11, wherein the mount is configured to attach to a transport system of the aircraft.

13. A method of coupling a motorcycle to an aircraft, using a mount, the mount comprising a support arm configured to couple to the aircraft, a first support coupled to the support arm, and a second support coupled to the first support, comprising:
coupling the support arm of the mount to the aircraft;
coupling the motorcycle to the mount;

14. The method of claim 13, wherein the coupling of the mount to the motorcycle and the mount to the aircraft is performed without the use of tools.

15. The method of claim 13, wherein the first support supports the body of the motorcycle.

16. The method of claim 15, wherein the second support couples to the front wheel of the motorcycle.

17. The method of claim 16, wherein the mount further comprises of a third support coupled to the first support, wherein the third support cradles the rear wheel of the motorcycle.

18. The method of claim 17, wherein the mount is further comprising of a fourth support coupled to the first support and a fifth support coupled to the support arm, wherein the fourth support couples to a first foot peg of the motorcycle and the fifth support couples to a second foot peg of the motorcycle.

19. The method of claim 18, wherein the mount attaches to a transport system of the aircraft.

20. A mount, configured to quickly couple and decouple a motorcycle to a helicopter without the use of tools, comprising:
a support arm configured to attach to a transport system of the helicopter;
a first support coupled to the support arm and configured to support a body of the motorcycle;
a second support coupled to the first support and configured to couple to the front wheel of the motorcycle;
a third support coupled to the first support and configured to cradle the rear wheel of the motorcycle;
a fourth support coupled to the first support and configured to couple to a first foot peg of the motorcycle; and
a fifth support coupled to the support arm and configured to couple to a second foot peg of the motorcycle.
